(19) United States
(12) Patent Application Publication
(10) Pub. No.: US 2012/0032486 A1
(43) Pub. Date: Feb. 9, 2012

(54) VEHICLE SEAT CONSTRUCTION

(75) Inventors: Charles Robert Baker, Northville, MI (US); Kurt A. Seibold, Whitmore lake, MI (US)

(73) Assignee: JOHNSON CONTROLS TECHNOLOGY COMPANY, Holland, MI (US)

(21) Appl. No.: 13/140,928

(22) PCT Filed: Dec. 24, 2009
(86) PCT No.: PCT/US2009/069524

§ 371 Date: Oct. 26, 2011

Related U.S. Application Data
(60) Provisional application No. 61/140,742, filed on Dec. 24, 2008.

(51) Int. Cl. B60N 2/20; B60N 2/44; B60N 2/22; A47C 5/00; A47C 5/12; B60N 2/68; A47C 7/02; A47C 7/14

(52) U.S. Cl. 297/354.1; 297/452.1; 297/284.2

(57) ABSTRACT

A seat construction for providing a seat back or base support, such as for a seat back, includes a planar member and an elastomeric fastener. The planar member is positioned on a portion of the seat and stretched thereon to create tension on the planar member and for providing structural support for an occupant of the seat. The elastomeric fastener is coupled to the planar member and to the seat for fastening the flexible planar member to the seat and maintaining the tension on the planar member.

### CROSS-REFERENCE TO RELATED APPLICATIONS

This application claims the benefit of and priority to U.S. Provisional Patent Application No. 61/140,742, filed Dec. 24, 2008, titled: VEHICLE SEAT CONSTRUCTION, in the name of Baker, et al. which is incorporated by reference herein.

### BACKGROUND

The present disclosure relates generally to the field of vehicle seating. More specifically, this disclosure relates to a vehicle seat construction including a seat frame cushion support and insert assembly.

Generally, known vehicle seats are constructed from a number of elements including internal structural support mechanisms coupled to a seat frame assembly. These known vehicle seats also include a system of steel springs coupled to the seat base and seat back frame. A cushion or padding layer made of expanded urethane foam is positioned on top of the steel spring system to support the weight of and provide comfort for the occupant. The seat is then generally covered by a fabric, vinyl or leather upholstery cover member to provide protection and an acceptable aesthetic appearance. The design of these known vehicle seats renders the seat relatively heavy with a bulky profile which leaves little space beneath the seat and generally occupies an exorbitant amount of space in the vehicle. These known vehicle seats also tend to have high manufacturing and assembly costs and hinder vehicle fuel efficiency.

There remains a significant and continuing need to provide an improved vehicle seat assembly that provides improved design, performance and lower cost assembly while providing enhanced comfort for the occupant while meeting ever increasing performance requirements. There also remains a significant and continuous need to provide an improved vehicle seat assembly that has a lower manufacturing and assembly cost and is lighter in weight (reduced mass) to enhance vehicle fuel efficiency while meeting ever increasing performance requirements.

### SUMMARY

A seat construction, for providing support to a seat, includes a planar member and an elastomeric fastener. The planar member is positioned on a portion of the seat and stretched thereon to create tension on the planar member and for providing structural support for an occupant of the seat. The elastomeric fastener is coupled to the planar member and to the seat for fastening the flexible planar member to the seat and maintaining the tension on the planar member.

A vehicle seat assembly, for use in a vehicle, includes a seat back frame, a seat base frame, a seat construction having a planar member and an elastomeric fastener. The seat back frame includes a first side frame member, a second side frame member, an upper cross member, and a lower cross member. The seat base frame includes a first side frame member, a second side frame member, a front cross member, and a rear cross member. The seat back frame is pivotably coupled to a seat base frame. The planar member is positioned on a portion of the seat and is stretched thereon to create tension on the planar member and provide structural support for an occupant of the seat. The elastomeric fastener is coupled to the planar member and to the seat to thereby fasten the flexible planar member to the seat and maintain tension on the planar member.

### BRIEF DESCRIPTION OF THE DRAWINGS

FIG. 1 is a perspective view of a vehicle having a vehicle seat assembly according to an exemplary embodiment.

FIG. 2 is a perspective view of the vehicle seat assembly of FIG. 1 according to an exemplary embodiment.

FIG. 3 is a perspective view of the vehicle seat assembly of FIGS. 1 and 2 showing the seat trim cover partially removed and disclosing a seat frame support insert coupled thereto according to an exemplary embodiment.

FIG. 4 is a perspective view of a seat back frame assembly having a seat frame support insert coupled thereto according to an exemplary embodiment.

FIG. 5 is cross-sectional view of the seat back frame assembly of FIG. 4 further detailing the seat frame support insert coupled thereto according to an exemplary embodiment.

FIG. 6 is an enlarged view of the seat frame side member of FIG. 5 according to an exemplary embodiment.

FIG. 7 is an alternate cross-sectional view of the seat back frame assembly of FIG. 4 detailing the seat frame support insert thereto coupled and cushion pad according to an exemplary embodiment.

FIG. 8 is a partial, front schematic view of a connector member of the seat frame support insert and material of FIG. 4 according to an exemplary embodiment.

FIG. 9 is a perspective view of the connector member of the seat frame support insert of FIG. 4 according to an exemplary embodiment.

FIG. 10 is a partial, cross-sectional view of a seat base assembly having a seat frame support insert coupled thereto according to an exemplary embodiment.

### DETAILED DESCRIPTION

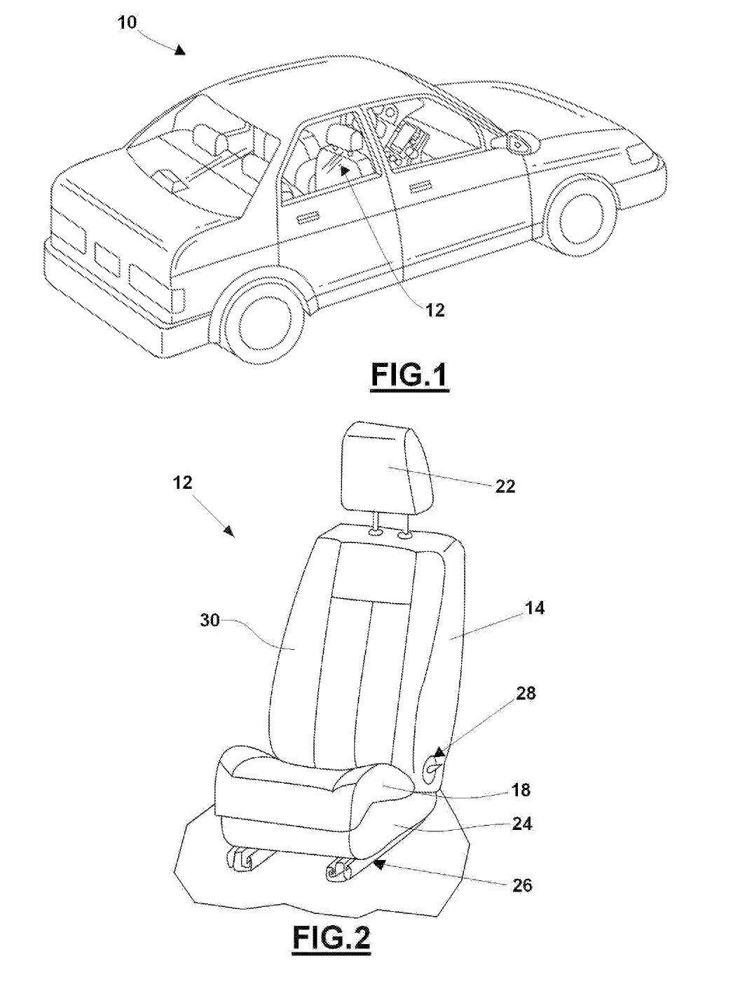

Referring generally to the figures and in particular to FIG. 1, a vehicle 10 is shown according an exemplary embodiment. The vehicle includes one or more vehicle seats 12 provided for occupants of the vehicle 10. While the vehicle 10 shown is a 4-door sedan, it should be understood that the vehicle seat 12 may be used in a mini-van, sport utility, cross-over or any other type of vehicle or any other means in or by which someone travels or something is carried or conveyed for any market or application including everything from office seating and transportation to planes and space travel and everything in between. The vehicle seat 12 shown includes a seat frame 13, a seat back 14 in the form of a seat back assembly 16 and a seat cushion 18 in the form of a seat cushion assembly 20. An exemplary embodiment of an upholstered vehicle seat structure 12 according to the exemplary embodiment is shown in FIG. 2. The vehicle seat 12 may, and typically does, include a head restraint 22 and a seat base portion 24 for supporting the seat cushion 18. Generally, the head restraint 22 extends upward from the seat back 14 and is configured to restrain the head of an occupant during an impact. The seat cushion 18 and/or base portion 24 may be configured to allow the vehicle seat 12 to be selectively adjusted and positioned (manually or motor driven) relative to the vehicle interior via a track assembly 26. The vehicle seat 12 may also include a recliner mechanism 28 for pivotably adjusted the seat back 14 relative to the seat base portion 24. The vehicle seat 12 may also include a trim cover 30 and other additional components, such as, foam padding, and the like, to further enhance comfort and aesthetic appearance of the vehicle seat.

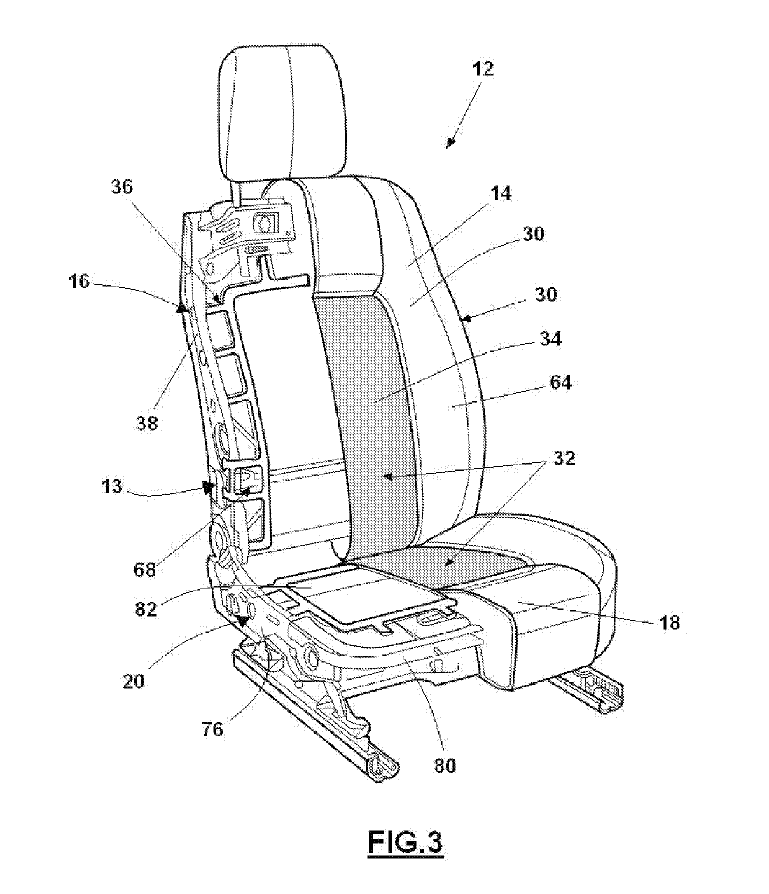

Referring now to FIG. 3, a vehicle seat assembly 12 with the seat trim cover 30 and cushion 18 partially removed and having a seat frame support insert 32 coupled thereto is shown. The seat frame support insert 32 includes, inter alia, a support member 34 (e.g., a generally planar material made from an appropriate flexible and stretchable fabric or material, etc.) coupled to an elastomeric fastener 36 for connecting the support member 34 to the seat frame 13. The seat frame support insert 32 may be coupled to the seat back frame 16 (e.g., first and second vertical side members, upper and lower cross members, etc.) and/or the seat base frame 20 (e.g., inboard and outboard side members (b-brackets), front and rear cross members, etc.) via the elastomeric fasteners 36 which will be described in further detail below. The periphery of the seat back frame 16 and seat base frame 20 may be covered with material (e.g., foam, etc.) to provide further support, comfort, protection, and the like, to an occupant and may also be covered with a seat cover (i.e., trim cover) 30 made of a suitable material (e.g., fabric, leather, a faux leather, vinyl, or any other known or appropriate material).

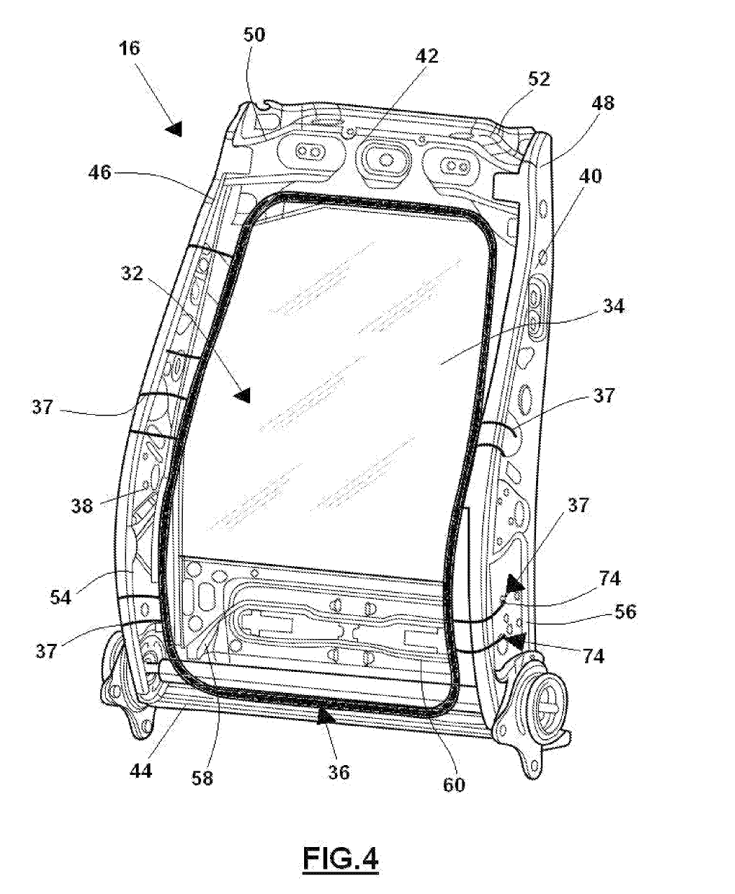

Referring now to FIG. 4, a seat back frame assembly 16 having a high tension support insert coupled thereto is shown. The seat back frame assembly 16 includes a pair of opposing first and second vertical side members 38, 40, an upper horizontal cross member 42, and a lower horizontal cross member 44. However, the seat frame assembly 16 may be made using virtually any known or appropriate construction and collection of members which may be combined to function as a vehicle seat frame assembly. The upper end of the first vertical side member 46 and the upper end of second vertical side member 48 are each coupled to the first and second end of the upper horizontal cross member 50, 52, respectively. The lower end of the first vertical side member 54 and the lower end of the second vertical side member 56 are each coupled to the first and second end of the lower horizontal cross member 58, 60, respectively, such that a substantially rectangular frame is constructed 16. The seat frame support insert 32 is positioned within/on the seat back frame assembly 16 and is coupled to the seat back frame 16 via the elastomeric fasteners 36 (and fastener extensions 37) to create relatively high tension on the planar member 34 (e.g., fabric, material, etc.) of the seat frame support insert 32 such that the insert 32 provides structural support and comfort for the occupant of the vehicle seat 12. The elastomeric fasteners 36 may be created in various configurations (e.g., number of fasteners, elasticity, length, size, dimension, orientation, location of fastener extensions/nodules, etc.) to provide varying support along the vertical and horizontal axis of the high tension support insert 32. The generally planar member 34 of the high tension support insert 32 may have a variety of dimensions, shapes, sizes, thicknesses, textures, patterns, weaves, colors, and be made from any variety of suitable and appropriate materials including, among other things, woven natural and synthetic fibers, fiber reinforced plastic sheeting, fabric, mesh, plastic, leather, vinyl, pleather, rubber, and the like.

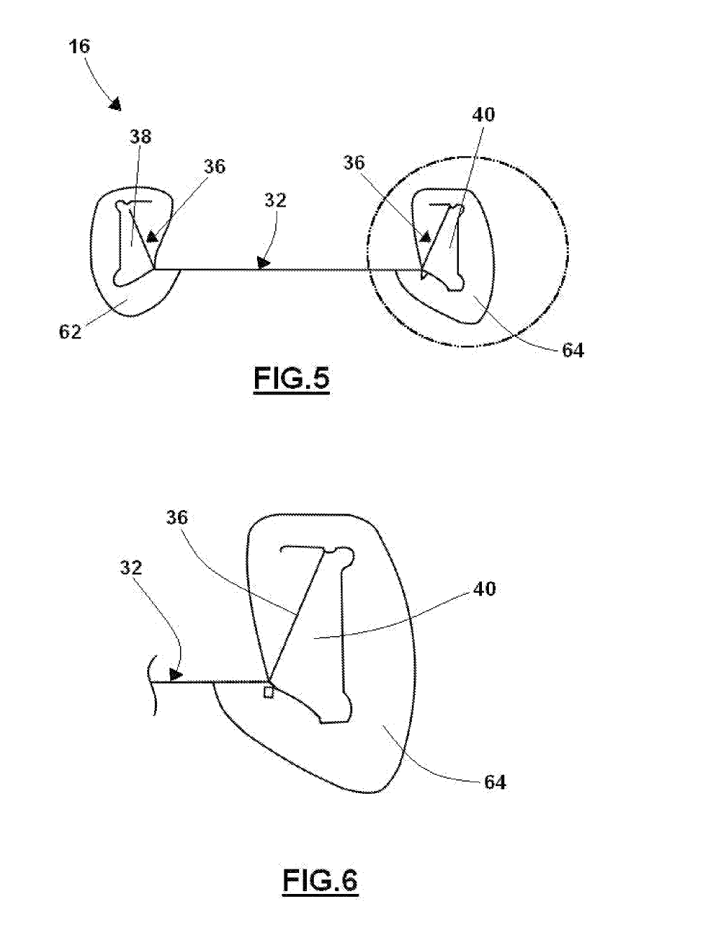

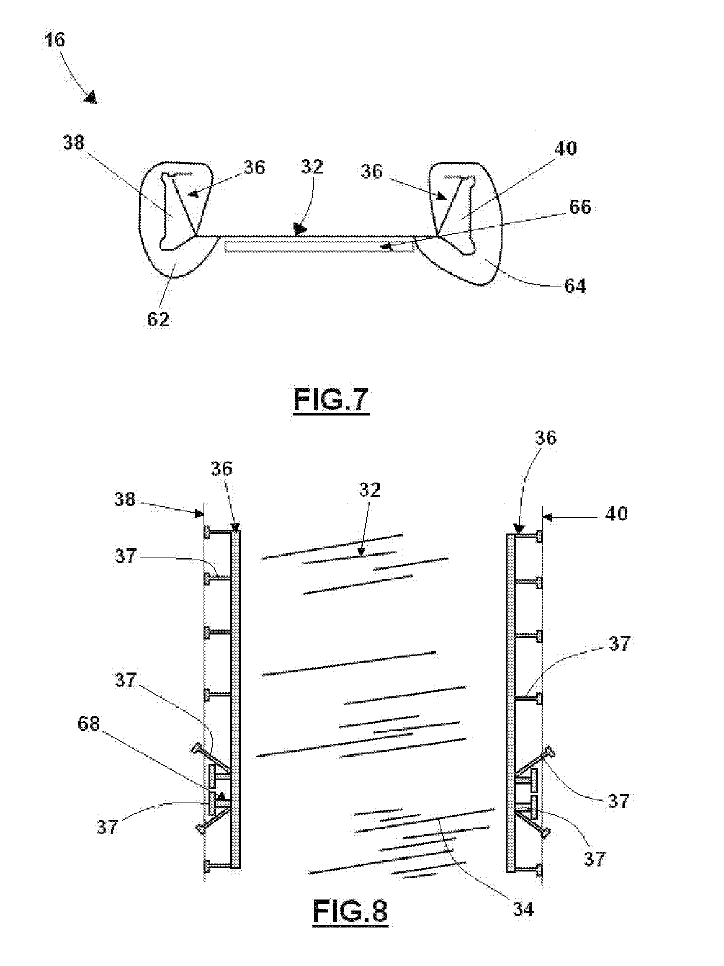

Referring now to FIGS. 5 through 7, a top cross-sectional view of the lumbar area of a seat back frame assembly 16 having a high tension support insert 32 coupled thereto is shown. The high tension support insert 32 is drawn or “stretched” from the first vertical side member 38 to the second vertical side member 40 and from the upper cross member 42 to the lower cross member 44 via the elastomeric fastener 36. Side bolsters 62, 64 are coupled to the first and second vertical side members 38, 40 such that the three sides of the vertical side members 38, 40 are enclosed. The side bolsters 62, 64 may have a variety of dimensions, shapes, sizes, thicknesses, textures, patterns, colors, and be made from a variety of suitable materials including, among other things, foam, woven natural and synthetic fibers, fiber reinforced plastic sheeting, fabric, mesh, plastic, rubber, and the like. According to one embodiment, a foam pad insert 66 may also be included on the seat back 14 and/or the seat base/cushion 18 for added comfort and support, as best shown in FIG. 7.

Referring now to FIG. 8, a seat back frame assembly 16 having a high tension support insert 32 coupled thereto via an elastomeric fastener 36 is shown. Tension on the high tension support insert 32 may be tuned vertically (longitudinally) along the strip of the elastomeric fastener 36 as needed and/or as appropriate by, among other things, creating an elastomeric fastener 36 that is less elastic on the front side, altering the thickness of the elastomeric fastener 36 and/or the fastener extensions 37, altering the location of where the elastomeric fasteners 36 are coupled to the seat frame 13, etc. The fastener 36 may also be configured to be less elastic in the lumbar zone 68 by using more rigid extensions 37 (i.e., less compliant ties) to create a higher pressure zone and by using additional extensions 37 (ties) that “tie off” or couple toward the rear of the seat assembly and thereby further stabilize the high tension support insert 32 in the lumbar zone 68.

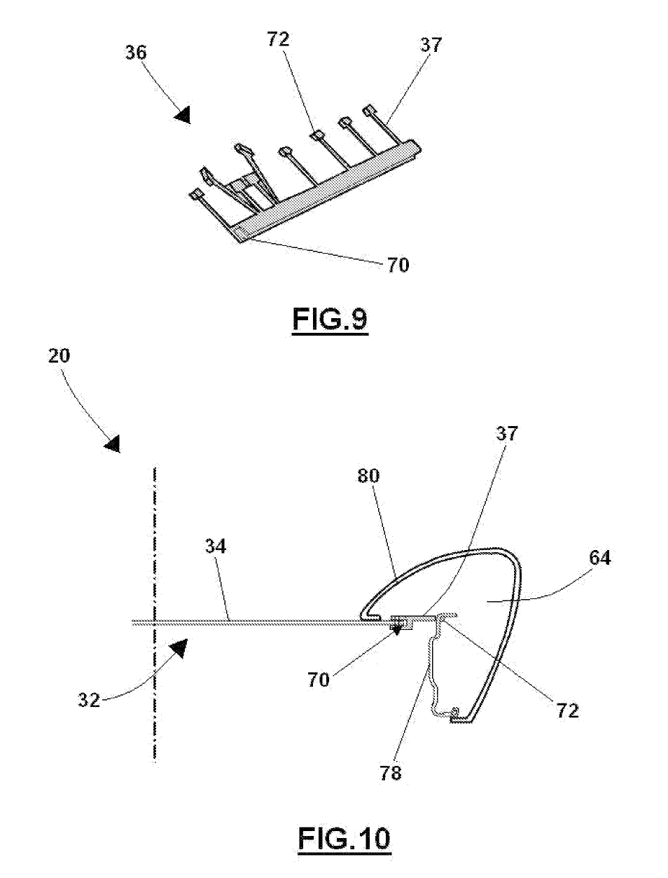

FIG. 9 shows the elastomeric fastener of FIG. 8. The elastomeric fastener (tie down strip) 36 has a U-shaped channel 70 that receives and securely retains (e.g., sewn, adhered, glued, etc.) the peripheral edges of the planar member 34 (e.g., fabric, material, etc.). The elastomeric fastener 36 also includes a plurality of extensions 37 that enable the high tension support insert 32 to be drawn or stretched and coupled to the seat back frame assembly 16 to provide a force in the material of the insert 32. The extensions 37 have coupling nodules (members, bodies, etc.) 72 that are inserted into apertures 74 (openings, notches, slots, slits, windows, receivers, etc.) on the seat frame 13 to facilitate coupling thereto. While a tab and slot type coupling nodule 72 is disclosed it should be understood that any type of coupling may be used provided it couples the elastomeric fastener 36 to the seat frame 13 and couples the planar member thereto 34.

Referring now to FIG. 10, a front cross-sectional view of a seat base frame assembly 20 having a high tension support insert 32 coupled thereto is shown. The high tension support insert 32 is positioned within/on the seat base frame 20 and is drawn or “stretched” from the one side member 76 to the second side member 78 and from the front cross member 80 to the rear cross member 82 and coupled thereto via the elastomeric fastener 36 which is coupled (e.g., sewn, glued, adhered, etc.) to the planar member 34 (e.g., fabric, material, etc.). The elastomeric fastener 36 is coupled to the seat base frame 20 by the elastomeric fastener 36 such that the support insert 32 provides structural support and comfort for the occupant. The bolster trim flap 80 of the seat base cushion 18 may be coupled (e.g., sewn, etc.) to the planar member 34 (e.g., fabric, material, etc.) of the high tension support insert 32 to further secure the high tension support insert 32 to the seat base 18 and to provide additional support and comfort for the occupant.

For purposes of this disclosure, the term “coupled” means the joining of two components (mechanical and/or electrical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

It is also important to note that the construction and arrangement of the elements of the vehicle seat as shown in the preferred and other exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present innovations. Other substitutions, modifications, changes and omissions may be made in the design, operating conditions and arrangement of the preferred and other exemplary embodiments without departing from the spirit of the present innovations.

What is claimed is:

1. A seat construction for providing support to a seat, comprising:
a planar member positioned on a portion of the seat and stretched thereon to create tension on the planar member and for providing structural support for an occupant of the seat;
an elastomeric fastener coupled to the planar member and to the seat for fastening the flexible planar member to the seat, wherein the elastomeric fastener includes an extension for securing the planar member to the seat and adjusting the tension on the planar member

2. The seat construction of claim 1, wherein the fastener is an elastomeric fastener and includes a channel therein for receiving and securing at least a portion of the planar member.

3. The seat construction of claim 1, wherein the elastomeric fastener includes a plurality of elastomeric extensions for varying the tension along the planar member.

4. The seat construction of claim 1, wherein the extension includes a nodule for insertion into an aperture located on the seat.

5. The seat construction of claim 1, wherein the elastomeric fastener includes a plurality of elastomeric extensions to provide varying support along the vertical and horizontal axis of the planar member by adjusting at least one of the number, length, size, elasticity, dimension, orientation, and location of the elastomeric extension.

6. The seat construction of claim 1, wherein the planar member is made from a material including woven natural fibers, woven synthetic fibers, fiber reinforced plastic sheeting, fabric, mesh, plastic, leather, vinyl, pleather, or rubber.

7. A vehicle seat assembly for use in a vehicle, the vehicle seat assembly comprising:
a seat back frame for a seat having a first side frame member, a second side frame member, an upper cross member, and a lower cross member;
a seat base frame for the seat having a first side frame member, a second side frame member, a front cross member, and a rear cross member, wherein the seat back frame is pivotably coupled to a seat base frame;
a planar member positioned on a portion of the seat and stretched thereon to create tension on the planar member and for providing structural support for an occupant of the seat;
an elastomeric fastener coupled to the planar member and to the seat for fastening the flexible planar member to the seat, wherein the elastomeric fastener includes an extension for securing the planar member to the seat and adjusting the tension on the planar member.

8. The seat construction of claim 7, wherein the planar member is coupled to at least one of the seat back frame or the seat base frame.

9. The seat construction of claim 7, wherein the elastomeric fastener includes a channel for receiving a portion of the planar member and the planar member is secured therein.

10. The seat construction of claim 7, wherein the elastomeric fastener includes a plurality of elastomeric extensions for varying the tension along the planar member.

11. The seat construction of claim 7, wherein the extension includes a nodule for insertion into an aperture located on the seat.

12. The seat construction of claim 7, wherein the elastomeric fastener includes a plurality of elastomeric extensions to provide varying support along the vertical and horizontal axis of the planar member by adjusting at least one of the number, length, size, elasticity, dimension, orientation, and location of the elastomeric extensions.

13. The seat construction of claim 7, wherein the planar member is flexible and made from at least one of woven natural fibers, woven synthetic fibers, fiber reinforced plastic sheeting, fabric, mesh, plastic, leather, vinyl, pleather, or rubber.

14. The seat construction of claim 7, wherein the seat assembly further includes a first side bolster member coupled to the first side member of the seat back frame and a second side bolster member coupled to the second side member of the seat back frame.

15. The seat construction of claim 7, wherein the seat assembly further includes a first side bolster member coupled to the first side member of the seat base frame and a second side bolster member coupled to the second side member of the seat base frame; wherein a portion of the first and second side bolster member is coupled to the planar member.
